(19) United States
(12) Patent Application Publication
(10) Pub. No.: US 2005/0042502 A1
(43) Pub. Date: Feb. 24, 2005

(54) Battery carrier

(76) Inventor: Joel A. Becker, Chicago, IL (US)

Correspondence Address: OLSON & HIERL, LTD., 36th Floor, 20 North Wacker Drive, Chicago, IL, 60606, US

(21) Appl. No.: 10/646,973

(22) Filed: Aug. 22, 2003

(51) Int. Cl. H01M 2/10

(52) U.S. Cl. 429/99; 429/98; 429/100; 206/703

(57) ABSTRACT

A carrier of replacement batteries for a portable electronic device or the like. The carrier includes a housing defining receptacles adapted to receive and seat the replacement batteries and a plate incorporating strips of adhesive or the like material which allow the carrier to be secured directly to the surface of the device for which the replacement batteries may be needed at the point-of-use. In one embodiment, rotatable panels with ears hold the batteries in place in the carrier and clips are adapted to hold the panels down against the plate when the carrier is not in use. In another embodiment, rotatable collars are adapted to surround and hold the batteries in the receptacles.

### FIELD OF THE INVENTION

This invention relates to carriers and, more particularly, to a carrier adapted to store replacement batteries for a variety of portable electronic devices.

### BACKGROUND OF THE INVENTION

This invention addresses the all too common occurrence of having no replacement batteries readily available when any one of the several different types of portable electronic devices in common use today lose their power because of spent batteries. This problem is of particular concern when devices such as, for example, portable radios, CD players and cameras lose their power while the user is away from home and thus away from the place where replacement batteries are most typically stored.

This invention addresses this problem by providing a replacement battery carrier adapted to accompany and be secured directly to the surface of an electronic device thus allowing replacement batteries to be readily and conveniently available at the point-of-use of the device.

### SUMMARY OF THE INVENTION

The invention relates to a carrier for batteries comprising a housing defining one or more receptacles adapted to receive one or more batteries respectively and means associated with the housing for securing the carrier to a surface of an article.

In one embodiment, the one or more receptacles comprise spaced-apart and parallel elongate grooves defined in a platform associated with the housing. Also, in one embodiment, the housing includes a bottom wall and side walls which are rotatable about the bottom wall between a first position generally parallel to the bottom wall and a second position generally normal to the bottom wall. Each of the side walls include two independently rotatable panels. Each of the panels includes an inwardly bent ear portion adapted to abut against the ends of the batteries in the second position of the side walls. A clip on the bottom wall is adapted to hold the side walls in the first position.

In another embodiment, and in lieu of rotatable panels, the housing includes collars adapted to surround and secure the batteries in the platform of the carrier.

The means associated with the housing for securing the carrier to a surface of an article comprises a strip of adhesive material extending along the lower surface of the bottom wall.

Other advantages and features of the present invention will be more readily apparent from the following detailed description of the preferred embodiments of the invention, the accompanying drawings, and the appended claims.

### BRIEF DESCRIPTION OF THE DRAWINGS

In the accompanying drawings forming part of the specification in which like numerals are employed to designate like parts throughout the same:

FIG. 1 is a perspective view of the battery carrier of the present invention with replacement batteries carried therein;

FIG. 2 is a perspective view of the battery carrier of FIG. 1 without any batteries carried therein;

FIG. 3 is a vertical cross-sectional view of the carrier taken along the plane 3-3 in FIG. 2;

FIG. 4 is a bottom perspective view of the battery carrier of FIG. 1;

FIG. 5 is a perspective view of an alternate embodiment of the battery carrier of the present invention with replacement batteries carried therein; and

FIG. 6 is a perspective view of the battery carrier of FIG. 5 in its open configuration without any batteries carried therein.

### DETAILED DESCRIPTION OF THE PREFERRED EMBODIMENTS

The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

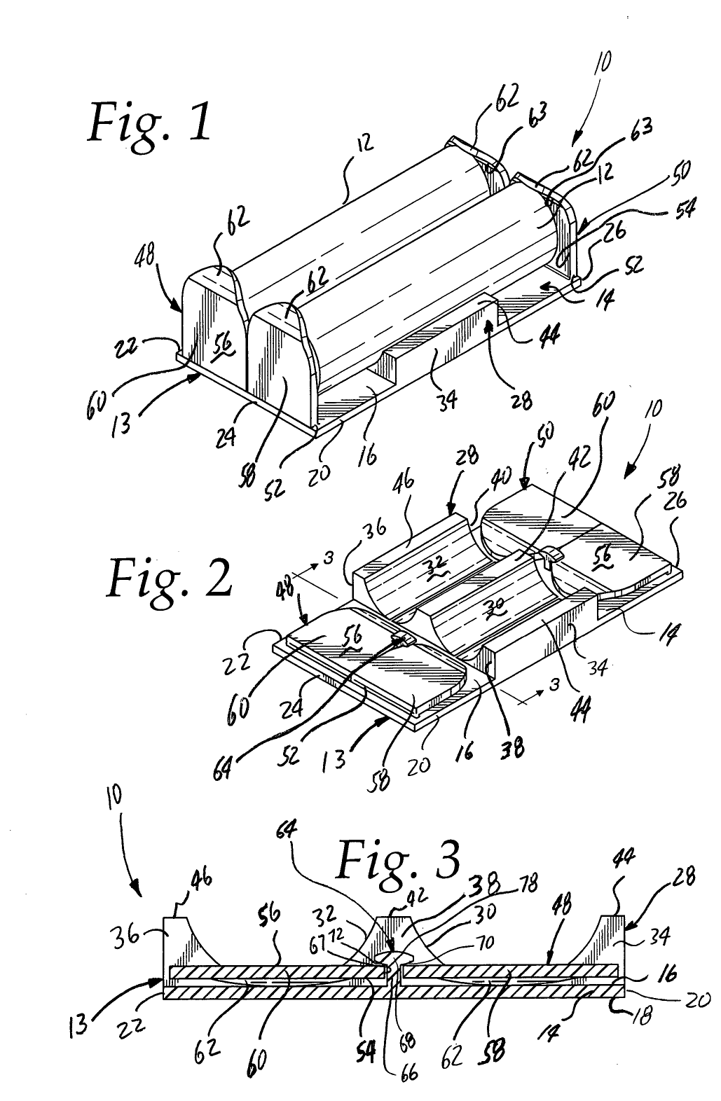

FIGS. 1-4 depict a first embodiment of a carrier 10 incorporating the features of the present invention and adapted to removably secure, store, and carry batteries 12.

Carrier 10 initially comprises a housing 13 made of any suitable durable material such as plastic and including an elongate bottom plate, floor, or wall 14 which, in the embodiment shown, is generally rectangularly shaped and includes upper and lower generally flat faces 16 and 18 respectively, longitudinally extending peripheral side faces 20 and 22 and transverse end faces 24 and 26.

Housing 13 additionally comprises a generally rectangularly shaped block or platform 28 extending unitarily outwardly and upwardly from the upper face 16 of the plate 14. Platform 28 defines a pair of elongate receptacles or compartments 30 and 32 defining grooves or troughs adapted to receive and carry the batteries 12. Platform 28 includes opposed generally vertical side walls 34 and 36 extending unitarily outwardly and upwardly from the upper face 16 of the plate 14 in a generally vertical co-planar relationship with the side faces 20 and 22 of the plate 14. Platform 28 also includes a pair of opposed, spaced-apart and parallel vertical end walls 38 and 40 protruding unitarily outwardly and upwardly from the upper face 16 of the plate 14 and extending between the side faces 20 and 22 of the plate 14 in spaced-apart and parallel relationship.

In the embodiment of FIGS. 1-4, battery receptacles 30 and 32 extend in the longitudinal direction between and through the vertical end walls 38 and 40 of the platform 28. In the transverse direction, the receptacles 30 and 32 extend in a side-by-side and parallel relationship relative to each other and the side faces 20 and 22 of plate 14. In the embodiment shown, the receptacles 30 and 32 are generally semi-cylindrically shaped and adapted to receive two AAA size batteries respectively. Platform 28 additionally defines a flat elongate generally horizontal band 42 extending between the compartments 30 and 32 and respective elongate end bands 44 and 46 located adjacent the top peripheral longitudinal edge of the platform side walls 34 and 36. Bands 42, 44 and 46 extend longitudinally between the vertical end walls 38 and 40 of platform 28 in a spaced-apart and parallel relationship.

Housing 13 additionally includes a pair of rotatable side walls 48 and 50. Side walls 48 and 50 are unitarily, rotatably and hingedly secured to the upper face 16 of plate 14 along a lower peripheral elongate hinge portion 52 thereof disposed adjacent and generally parallel to the end faces 24 and 26 respectively of plate 14 and extending in the transverse direction generally between the side faces 20 and 22 of the plate 14.

Each of the side walls 48 and 50 includes inner and outer surfaces 54 and 56 respectively and defines two separate independently rotatable and pivotable panels 58 and 60. Each of the panels 58 and 60 is rotatable between a first position as shown in FIGS. 2 and 3 where the panels 58 and 60 are positioned in a generally horizontal relationship with the inner surface 54 thereof adjacent from and generally parallel to the upper face 16 of the plate 14 and a second position as shown in FIG. 1 where the panels 58 and 60 have been rotated in a counter-clockwise direction about the hinge 52 thereof into a generally vertical and normal upright position relative to the plate 14.

Each of the panels 58 and 60 includes an inwardly bent tip or ear portion 62 which defines a grip tab for easily and conveniently rotating the panels 58 and 60 between the FIG. 1 and FIG. 2 positions. The ear 62 additionally defines an interior shoulder 63 adapted to abut against the peripheral circumferential edge of the ends of each of the batteries 12 to keep the batteries firmly and tightly removably secured in the carrier 10 as shown in FIG. 1.

As shown in FIGS. 2 and 3, a clip 64 is adapted to secure and lock each of the side walls 48 and 50 down against the plate 14. Each of the clips 64 includes a leg 66 which extends generally vertically and unitarily outwardly and upwardly from the upper face 16 of the plate 14 between and through a space or gap 67 defined between the panels 58 and 60 of each of the side walls 48 and 50 in the region of the respective rounded or arcuate ear portions 62 thereof.

Each of the clips 64 also includes a unitary head 68 extending generally horizontally across the top of the leg 66 and over a portion of the peripheral edge of both of the panels 58 and 60 of each of the side walls 48 and 50 in the closed carrier position of FIGS. 2 and 3. Head 68 includes lower faces 70 and 72 respectively which diverge and curve outwardly and upwardly away from each side of the leg 66, flat generally vertical side faces 74 and 76 extending upwardly away from the distal end of the faces 70 and 72 respectively and an upper face 78 which extends between the respective side faces 74 and 76 in an arcuate, convex relationship thereto.

Although not shown in any of the FIGURES, it is understood that the upper face 78 of the head 68 of each of the clips 64 is shaped to cause the clips 64 and, more particularly, the legs 66 thereof respectively to flex or bend away from the respective panels 58 and 60 in response to contact between the edges of the respective panels and the face 78 of the head 68 when the panels 58 and 60 are rotated between the FIG. 1 position and the FIG. 2 and 3 positions where the panels 58 and 60 have been snapped by the clips 64 into abutting and secured position against the plate 14.

In the same manner, and although not shown in any of the FIGURES, it is understood that the shape of the lower faces 70 and 72 of the head 66 of each of the clips 64 allows the clips 64 and, more particularly, the legs 66 thereof to flex outwardly away from the respective panels 58 and 60 in response to contact between the edges of the respective panels 58 and 60 and the respective faces 70 and 72 when the panels 58 and 60 are respectively rotated counter-clockwise from the FIG. 2 locked position to the FIG. 1 open position.

For example, it is understood that when the panel 58 of side wall 48 is rotated from its FIG. 1 position to the FIG. 2 position, the peripheral edge thereof in the region of the ear portion 62 thereof will come into contact with the face 78 of the clip 64 which, in turn, will cause the leg 66 of the clip 64 to flex away from the panel 58 and then flex back after the panel 58 has cleared the head 68 thereby locking the panel 58 against the plate 14. A similar action occurs when the opposed panel 60 is rotated down and locked against the plate 14. The panels 58 and 60 are unlocked in a similar manner as a result of contact between the edge of the respective panels 58 and 60 and the respective lower faces 70 and 72 of the head 68 of the clip 64.

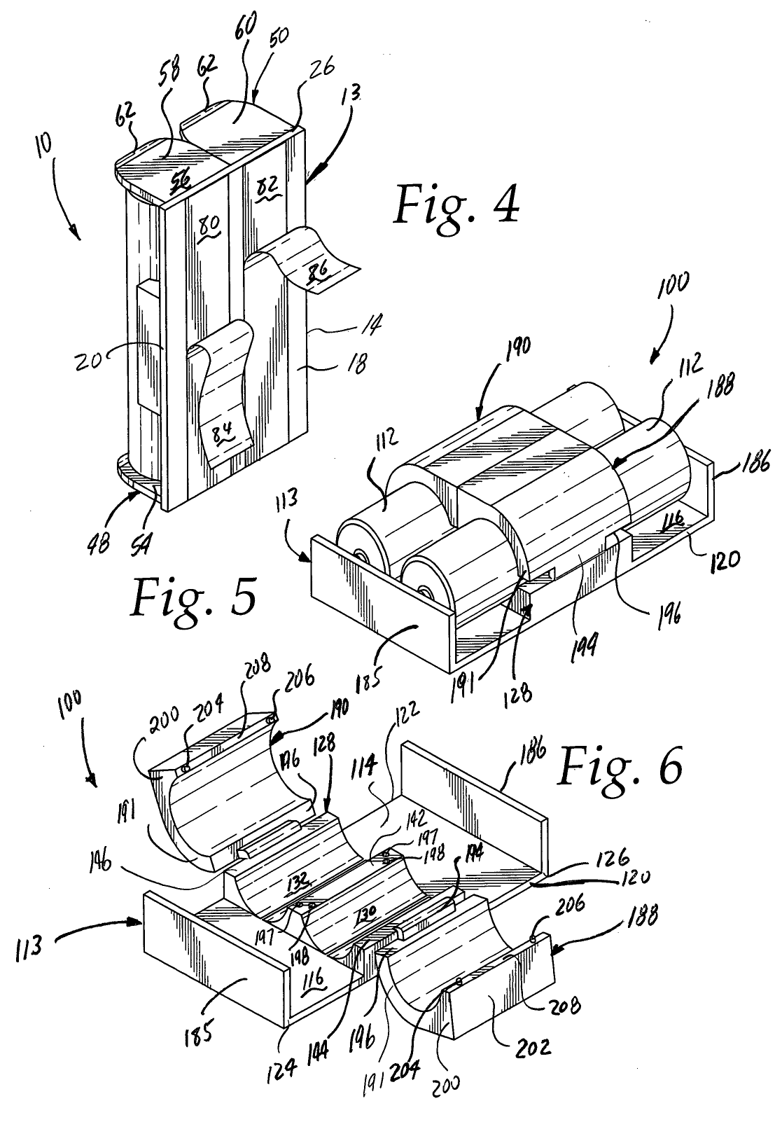

As shown in FIG. 4, a pair of layers of adhesive or the like material 80 and 82 extend along the lower face 18 of the plate 14 in a longitudinal and spaced-apart relationship between the end faces 24 and 26 thereof. Protective elongate strips of material 84 and 86 cover the layers of adhesive 80 and 82. In accordance with the present invention, and although not shown in any of the FIGURES, it is understood that the strips 84 and 86 are adapted to be stripped from the lower face 18 of plate 14 to reveal the layers of adhesive 80 and 82 and to allow the carrier 10 to be attached directly to a free surface of the device for which a user wishes to have replacement batteries readily and conveniently available at the point-of-use.

Referring to FIG. 1, batteries 12 are removed from the carrier 10 by gripping each of the panels 58 and 60 of each of the side walls 48 and 50 about the respective ears 62 thereof and then pulling the respective panels 58 and 60 laterally rearwardly away from the respective batteries 12 to free the same from the carrier 10. After the batteries 12 have been removed, the panels 58 and 60 naturally spring-bias and rotate clockwise in the direction of the closed position thereof of FIGS. 2 and 3. The panels 58 and 60 are then snapped into the respective clips 64 and into the locked position of FIGS. 2 and 3 as described above in detail.

Although the embodiment of the carrier 10 shown in the FIGURES includes strips of adhesive material, it is understood that the invention encompasses all other suitable means for securing the carrier 10 directly to the surface of another article or device such as, for example, cooperating strips of Velcro® material. Moreover, and although the carrier 10 shown in FIGS. 1-4 is adapted and sized to house a pair of AAA size batteries, it is understood that the carrier 10 may be sized to carry more than two batteries and further that the battery receptacles 30 and 32 may be shaped to receive other appropriately sized batteries. In the embodiment of FIGS. 1-4 where the carrier is adapted to house a pair of AAA size batteries, the carrier is approximately 1⅞ inches long by ⅞ inches wide and ½ inch high with the panels 58 and 60 in their extended position.

FIGS. 5 and 6 depict another carrier embodiment 100 in accordance with the present invention. Carrier 100 is similarly structured to the carrier 10 in several respects and the description of the elements of carrier 10 which are common to the carrier 100 are incorporated and applied herein by reference. The elements common to both carrier embodiments share the same first two identifying numerical digits.

Carrier 100 differs from carrier 10 in that, instead of rotatable side walls 48 and 50, carrier 100 incorporates a pair of stationary walls 185 and 186 extending unitarily outwardly, upwardly, and generally vertically co-planarly with, the end faces 124 and 126 respectively of the plate 114.

Additionally, housing 113 of carrier 100 includes a pair of battery covers or collars 188 and 190 adapted to surround the outer surface and bodies of the respective batteries 112 and removably secure the same within respective receptacles 130 and 132 in platform 128. Platform 128 and receptacles 130 and 132 are similarly structured to platform 28 and receptacles 30 and 32 of carrier 10 respectively.

Each of the collars 188 and 190 includes an arcuate body 189 terminating in a proximal longitudinal end wall 191 having a hinge 194 depending outwardly from a lower longitudinal end face 196 thereof. Hinge 194 connects and secures the respective covers 188 and 190 to the respective peripheral bands 144 and 146 extending along the top of the platform 128 of housing 113. The band 142 extending longitudinally between the two battery receptacles 130 and 132 defines two sets of apertures 197 and 198 therein.

Each of the collars 188 and 190 additionally includes a distal longitudinal end wall 200 opposite the proximal wall 191. Wall 200 has an outer flat face 202 and a pair of fingers 204 and 206 extending generally normally outwardly from a lower face 208 thereof.

The collar 188 is adapted to rotate counter-clockwise and the collar 190 is adapted to rotate clockwise about the platform 128 in the direction of the collar 188 between the open position of FIG. 6 and the closed position of FIG. 5. Although not shown in FIG. 5, it is understood that, in the closed position, the outer flat faces 202 of the walls 200 of the respective collars 188 and 190 are in abutting relationship, the lower face 208 of the respective walls 200 is in abutting relationship with the band 142, and the fingers 204 and 206 are interference fitted into the respective apertures 197 and 198 defined in the band 142 of platform 128 for removably securing the collars around the batteries.

It will be readily apparent from the foregoing detailed description of the invention and from the illustrations thereof that numerous variations and modifications may be effected without departing from the true spirit and scope of the novel concepts or principles of this invention.

1. A carrier for batteries comprising a housing defining one or more receptacles adapted to receive one or more batteries respectively and means associated with the housing for securing the carrier to a surface of an article.

2. The carrier of claim 1 wherein the one or more receptacles comprise spaced-apart and parallel elongate grooves defined in a surface of the housing.

3. The carrier of claim 1 wherein the housing includes a platform and the receptacles are defined in the platform.

4. The carrier of claim 1 wherein the housing includes a bottom wall and side walls rotatable about the bottom wall between a first position generally parallel to the bottom wall and a second position generally normal to the bottom wall.

5. The carrier of claim 4 wherein a clip on the bottom wall holds the side walls in the first position.

6. The carrier of claim 1 wherein the housing includes a bottom wall having a lower surface and the means associated with the housing for securing the carrier to a surface of an article comprises a strip of adhesive material extending along the lower surface of the bottom wall.

7. The carrier of claim 1 wherein the housing includes a collar adapted to surround the batteries.

8. The carrier of claim 7 wherein the housing includes a collar for each of the batteries and each of the collars is rotatable between an open position and a closed position surrounding the respective batteries.

9. A carrier for batteries comprising:
a housing including a bottom plate having upper and lower surfaces;
a platform extending outwardly from the upper surface of the bottom plate, the platform defining one or more receptacles adapted to receive one or more batteries respectively;
a side wall at each end of the bottom plate rotatable between a first position generally parallel to the upper surface of the bottom plate and a second position generally normal to the bottom plate and adapted to abut against the respective ends of the batteries;
a clip associated with each side wall and adapted to hold each of the side walls in the first position; and
means associated with the housing for securing the carrier to a surface of an article.

10. The carrier of claim 9 wherein each of the side walls includes an inwardly bent ear portion adapted to abut against the ends of the batteries.

11. The carrier of claim 9 wherein the platform defines a pair of spaced-apart elongate parallel receptacles extending along the length of the bottom plate and adapted to receive a pair of batteries respectively, the side wall at each end of the bottom plate defining two panels each having an inwardly bent ear portion, the clip at each end of the housing being located between the panels and adapted to hold both panels of each side wall in the first position.

12. The carrier of claim 9 wherein the means associated with the housing for securing the carrier to a surface of an article comprises a strip of adhesive material secured to the lower surface of the bottom plate.

13. A carrier for batteries comprising:
a housing including a bottom plate having upper and lower surfaces;
a platform extending outwardly from the upper surface of the bottom plate and defining one or more receptacles adapted to receive one or more batteries respectively;
one or more collars associated with the one or more receptacles respectively and adapted to surround the one or more batteries respectively; and
means associated with the housing for securing the carrier to a surface of an article.

14. The carrier of claim 13 wherein the platform defines a pair of spaced-apart receptacles extending along the length of the bottom plate and a pair of collars rotatable about the respective receptacles between an open position and a closed position surrounding the bodies of the batteries respectively.

15. The carrier of claim 14 wherein each of the collars includes an outer wall and the collars rotate towards each other into a relationship wherein the outer walls thereof abut each other.

16. The carrier of claim 15 wherein the receptacles are separated by an elongate band defined in the platform and the outer wall of each of the collars is adapted to abut against the band in the closed position of the collars.

17. The carrier of claim 16 wherein the band defines apertures and the outer wall of each of the collars includes fingers adapted to be interference fitted into the apertures in the closed position of the collars.

18. The carrier of claim 13 wherein the means associated with the housing for securing the carrier to a surface of an article comprises a strip of adhesive material on the lower surface of the bottom plate of the housing.
